(19) United States
(12) Patent Application Publication
(10) Pub. No.: US 2021/0005407 A1
(43) Pub. Date: Jan. 7, 2021

(54) KEYBOARD DEVICE

(71) Applicant: Primax Electronics Ltd., Taipei (TW)

(72) Inventor: Yu-Ming Lin, Taipei (TW)

(21) Appl. No.: 16/581,144

(22) Filed: Sep. 24, 2019

(30) Foreign Application Priority Data
Jul. 5, 2019 (TW) 108123803

(51) Int. Cl. H01H 13/83; G06F 3/023; H01H 13/7065

(52) U.S. Cl. CPC H01H 13/83; H01H 13/7065; G06F 3/023

(57) ABSTRACT

A keyboard device includes a membrane circuit board, a base plate, a key structure and a light-emitting element. The key structure includes a keycap, a connecting element and an elastic element. The connecting element is arranged between the base plate and the keycap. The elastic element is arranged between the keycap and the membrane circuit board. The light-emitting element is electrically connected with the membrane circuit board and located under the elastic element. After the light beams from the light-emitting element are projected upwardly and transmitted through the elastic element, the light beams are uniformly projected to the keycap. Consequently, the keycap has the uniform illuminous efficacy.

### FIELD OF THE INVENTION

The present invention relates to an input device and more particularly to a keyboard device.

### BACKGROUND OF THE INVENTION

Generally, the widely-used peripheral input device of a computer system includes for example a mouse device, a keyboard device, a trackball device, or the like. Via the keyboard device, characters and symbols can be inputted into the computer system directly. As a consequence, most users and most manufacturers of input devices pay much attention to the development of keyboards.

FIG. 1 is a schematic top view illustrating the outer appearance of a conventional keyboard device. As shown in FIG. 1, there are plural keys 10 on a surface of the conventional keyboard 1. These keys 10 are classified into several types, e.g. ordinary keys 101, numeric keys 102 and function keys 103. When one of these keys 10 is depressed by the user's finger, a corresponding signal is issued to the computer, and thus the computer executes a function corresponding to the depressed key. For example, when an ordinary key 101 is depressed, a corresponding English letter or symbol is inputted into the computer. When a numeric key 102 is depressed, a corresponding number is inputted into the computer. In addition, the function keys 103 (F1˜F12) can be programmed to provide various functions. For example, the conventional keyboard device 1 is a keyboard for a notebook computer.

With the maturity of the computing technologies, the keyboard manufacturers make efforts in designing novel keyboards with special functions in order to meet diversified requirements of different users. For this reason, luminous keyboards are favored by users. Hereinafter, the inner structure of the luminous keyboard will be illustrated in more details.

FIG. 2 is a schematic cross-sectional view illustrating a conventional luminous keyboard. As shown in FIG. 2, the conventional luminous keyboard 2 comprises plural key structures 20, a membrane circuit board 21, a light guide plate 22, an illumination module 23, a base plate 24 and a reflecting plate 25. Each key structure 20 comprises a keycap 201, a scissors-type connecting element 202 and an elastic element 203. From top to bottom, the keycap 201, the scissors-type connecting element 202, the elastic element 203, the membrane circuit board 21, the base plate 24, the light guide plate 22 and the reflecting plate 25 of the conventional luminous keyboard 2 are sequentially shown. The base plate 24 is arranged between the membrane circuit board 21 and the light guide plate 22 for supporting the keycap 201, the scissors-type connecting element 202, the elastic element 203 and the membrane circuit board 21.

In the key structure 20, the keycap 201 is exposed outside the conventional luminous keyboard 2, so that the keycap 201 can be depressed by the user. The scissors-type connecting element 202 is used for connecting the keycap 201 and the base plate 24. The elastic element 203 is penetrated through the scissors-type connecting element 202. In addition, both ends of the elastic element 203 are contacted with the keycap 201 and the membrane circuit board 21, respectively. The membrane circuit board 21 comprises an upper film layer 211, an intermediate layer 212 and a lower film layer 213. The upper film layer 211, the intermediate layer 212 and the lower film layer 213 are all made of a light-transmissible material. For example, the light-transmissible material is polycarbonate (PC) or polyethylene (PE). The upper film layer 211 comprises plural upper contacts 2111. The intermediate layer 212 is located under the upper film layer 211. Moreover, the intermediate layer 212 comprises plural intermediate layer openings 2121 corresponding to the plural upper contacts 2111. The lower film layer 213 is located under the intermediate layer 212. Moreover, the lower film layer 213 comprises plural lower contacts 2131 corresponding to the plural upper contacts 2111. Moreover, plural key switches 214 are defined by the plural lower contacts 2131 and the plural upper contacts 2111 collaboratively.

While the keycap 201 of any key structure 20 is depressed and moved downwardly relative to the base plate 24, the scissors-type connecting element 202 is switched from an open-scissors state to a stacked state. Moreover, as the keycap 201 is moved downwardly to compress the elastic element 203, the corresponding upper contact 2111 is pushed by the contacting part 2031 of the elastic element 203. Consequently, the corresponding upper contact 2111 is contacted with the corresponding lower contact 2131 through the corresponding perforation 2121. In such way, the corresponding key switch 214 is electrically conducted, and the keyboard device 2 generates a corresponding key signal.

The illumination module 23 comprises an illumination circuit board 231 and plural light-emitting elements 232. For clarification and brevity, only two light-emitting elements 232 are shown in the drawing. The illumination circuit board 231 is located under the membrane circuit board 21 for providing electric power to the plural light-emitting elements 232. The plural light-emitting elements 232 are side-view light emitting diodes and disposed on the illumination circuit board 231. In addition, the plural light-emitting elements 232 are inserted into plural reflecting plate openings 251 of the reflecting plate 25 and plural light guide plate openings 221 of the light guide plate 22, respectively. By acquiring the electric power, the plural light-emitting elements 232 are driven to emit plural light beams B. Moreover, the plural light beams B are introduced into the light guide plate 22. The light beams B are transferred through the light guide plate 22 and uniformly diffused to the whole light guide plate 22. The reflecting plate 25 is located under the light guide plate 22. The portions of the light beams B that are scattered downwardly from the light guide plate 22 are reflected back to the light guide plate 22 by the reflecting plate 25. Consequently, the utilization efficiency of the light beams B is enhanced. The two lateral edges 252 of the reflecting plate 25 are bent upwardly to enclose plural lateral edges 222 of the light guide plate 22. For clarification and brevity, only one lateral edge 252 of the reflecting plate 25 is shown in the drawing. Due to the lateral edges 252 of the reflecting plate 25, the problem of causing light leakage through the lateral edges 222 of the light guide plate 22 will be eliminated.

In the conventional luminous keyboard 2, each keycap 201 has a light-outputting zone 2011. The light-outputting zone 2011 is located at a character region or a symbol region of the keycap 201. Moreover, the position of the light-outputting zone 2011 is aligned with the position of a corresponding light-guiding dot 223 of the light guide plate 22. The light beams can be guided upwardly to the light-outputting zone 2011 by the corresponding light-guiding dot 223. After the plural light beams B are transferred within the light guide plate 22 and projected on the light-guiding dots 223, the light beams B are guided by the light-guiding dots 223 and projected upwardly. The upwardly-projected portions of the light beams B are sequentially transmitted through plural base plate openings 241 of the base plate 24 and the membrane circuit board 21 and transmitted through the plural light-outputting zones 2011 of the keycaps 201 so as to illuminate the character regions or the symbol regions of the keycaps 201. Under this circumstance, the illuminating function is achieved.

However, the conventional luminous keyboard still has some drawbacks. For example, all of the key structures of the luminous keyboard are simultaneously illuminated. In some situations, the user prefers to control illumination of respective key structures. For example, when the luminous keyboard is applied to an electronic sports product, it is necessary to illuminate one key structure but not illuminate another key structure. The use of the conventional luminous keyboard 2 cannot meet the user's requirement. For meeting the user's requirement, the luminous keyboard uses top-view light emitting diodes. FIG. 3 is a schematic cross-sectional view illustrating a portion of a conventional luminous keyboard using top-view light emitting diodes. The structure of the luminous keyboard 2′ is similar to that of FIG. 2 except that a single top-view light emitting diode 262 is located under the keycap 201 of each key structure 20. Moreover, each top-view light emitting diode is independently controlled to emit the light beams B.

An illumination circuit board 261 of the luminous keyboard 2′ is located under the membrane circuit board 21. The plural top-view light emitting diodes 262 are installed on the illumination circuit board 261 and inserted into the corresponding openings 215 of the membrane circuit board 21. By acquiring the electric power from the illumination circuit board 261, the plural top-view light emitting diodes 262 are driven to emit plural light beams B. The plural light beams B are projected upwardly and transmitted through the light-outputting zones 2011 of the corresponding keycaps 201. Consequently, the keycaps 201 are illuminated.

However, since the light beams emitted by the top-view light emitting diodes 262 are projected directly and upwardly to the corresponding keycaps 201, the light beams from the luminous keyboard 2′ are centralized. As shown in FIG. 1, the symbol regions 1041˜4044 (e.g., character regions or number regions) on the keycap 104 are located at the periphery region of the keycap 104. Since the light beams from the luminous keyboard 2′ are centralized, the luminance uniformity is usually unsatisfied. Therefore, the conventional keyboard device needs to be further improved.

### SUMMARY OF THE INVENTION

An object of the present invention provides a keyboard device. A light-emitting element is electrically connected with a membrane circuit board and located under an elastic element of a key structure. The light-emitting element is located at a middle region. After the light beams from the light-emitting element are projected upwardly and transmitted through the elastic element, the light beams are uniformly projected to the keycap. Consequently, the keycap has the uniform illuminous efficacy.

In accordance with an aspect of the present invention, a keyboard device is provided. The keyboard device includes a membrane circuit board, a base plate, a key structure and a light-emitting element. The membrane circuit board includes at least one membrane switch. The base plate is located under the membrane circuit board. The key structure includes a keycap, a connecting element and an elastic element. The keycap includes at least one contacting part. The connecting element is connected between the base plate and the keycap. The keycap is movable upwardly or downwardly relative to the base plate through the connecting element. The elastic element is arranged between the keycap and the membrane circuit board. While the keycap is depressed, the elastic element is compressed and the at least one membrane switch is pushed by the at least one contacting part. When the keycap is not depressed, the keycap is returned to an original position in response to an elastic force of the elastic element. The light-emitting element is located under the elastic element and electrically connected with the membrane circuit board. The light-emitting element emits plural light beams. After the plural light beams are transmitted through the elastic element and the keycap sequentially, the plural light beams are outputted.

In accordance with another aspect of the present invention, a keyboard device is provided. The keyboard device includes a membrane circuit board, a base plate, a key structure and a light-emitting element. The membrane circuit board includes two membrane switches. The base plate is located under the membrane circuit board. The key structure includes a keycap, a connecting element and an elastic element. The keycap includes two contacting parts corresponding to the two membrane switches. The connecting element is connected between the base plate and the keycap. The keycap is movable upwardly or downwardly relative to the base plate through the connecting element. The elastic element is arranged between the keycap and the membrane circuit board. While the keycap is depressed, the elastic element is compressed and at least one of the two contacting parts pushes the corresponding membrane switch. When the keycap is not depressed, the keycap is returned to an original position in response to an elastic force of the elastic element. The light-emitting element is electrically connected with the membrane circuit board. The light-emitting element emits plural light beams. The two membrane switches are not sheltered by the elastic element. Moreover, the two membrane switches are located beside two opposite sides of the light-emitting element.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic top view illustrating the outer appearance of a conventional keyboard device;

FIG. 2 is a schematic cross-sectional view illustrating a conventional luminous keyboard;

FIG. 3 is a schematic cross-sectional view illustrating a portion of a conventional luminous keyboard using top-view light emitting diodes;

FIG. 4 is a schematic perspective view illustrating the appearance of a keyboard device according to a first embodiment of the present invention;

FIG. 5 is a schematic exploded view illustrating a portion of the keyboard device as shown in FIG. 4 and taken along a first viewpoint;

FIG. 6 is a schematic exploded view illustrating a portion of the keyboard device as shown in FIG. 4 and taken along a second viewpoint;

FIG. 7 is a schematic cross-sectional view illustrating a portion of the keyboard device as shown in FIG. 4 and taken along the line XX;

FIG. 8 is a schematic cross-sectional view illustrating a portion of the keyboard device as shown in FIG. 4 and taken along the line YY; and

FIG. 9 is a schematic cross-sectional view illustrating a portion of a keyboard device according to a second embodiment of the present invention.

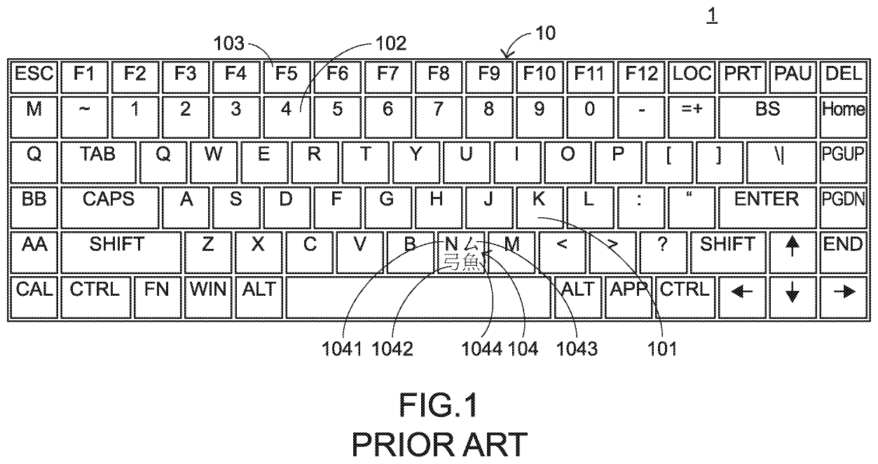

### DETAILED DESCRIPTION OF THE PREFERRED EMBODIMENT

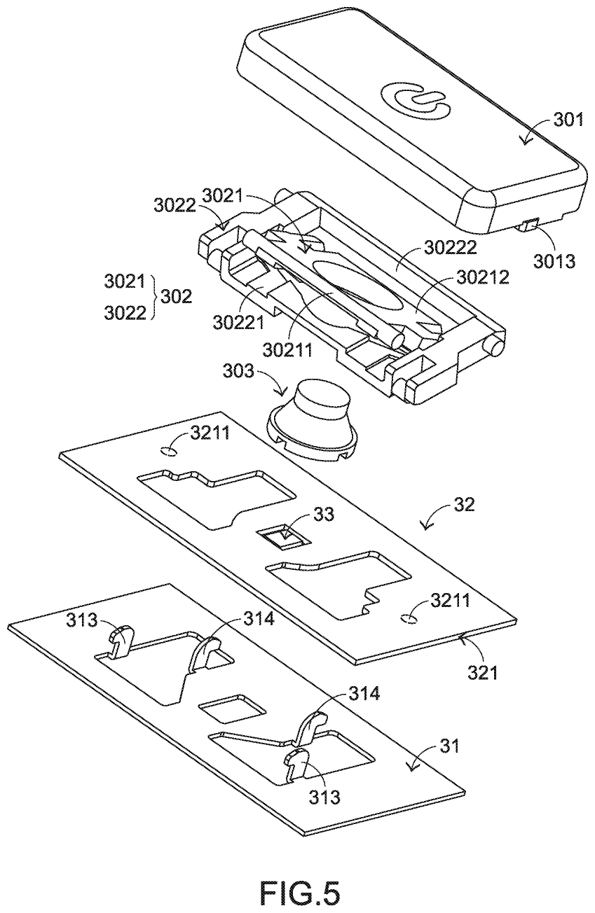

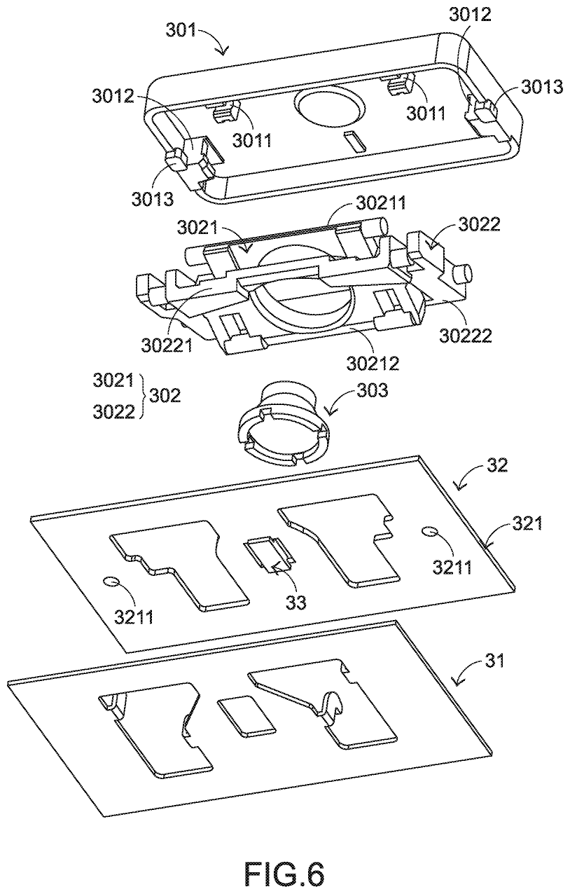

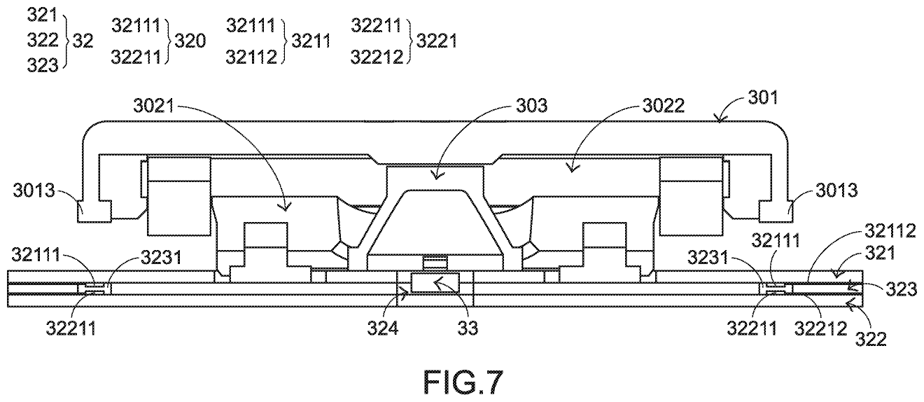

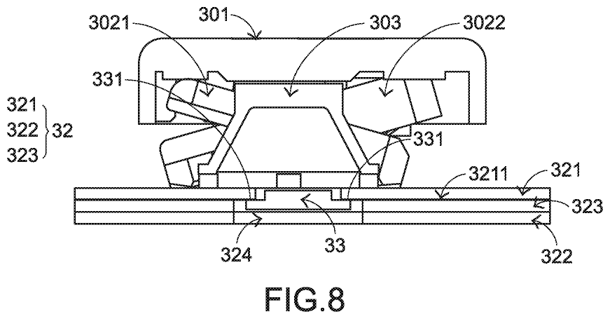

Please refer to FIGS. 4, 5, 6, 7 and 8. FIG. 4 is a schematic perspective view illustrating the appearance of a keyboard device according to a first embodiment of the present invention. FIG. 5 is a schematic exploded view illustrating a portion of the keyboard device as shown in FIG. 4 and taken along a first viewpoint. FIG. 6 is a schematic exploded view illustrating a portion of the keyboard device as shown in FIG. 4 and taken along a second viewpoint. FIG. 7 is a schematic cross-sectional view illustrating a portion of the keyboard device as shown in FIG. 4 and taken along the line XX. FIG. 8 is a schematic cross-sectional view illustrating a portion of the keyboard device as shown in FIG. 4 and taken along the line YY. For well understanding the present invention, the elements shown in the drawings are not in scale with the elements of the practical product and some components are not shown. For example, in FIGS. 5 and 6, the intermediate film layer and the lower film layer are not shown. In the following embodiments and drawings, the elements irrelevant to the concepts of the present invention or the elements well known to those skilled in the art are omitted. It is noted that numerous modifications and alterations may be made while retaining the teachings of the invention.

In this embodiment, the keyboard device 3 comprises plural key structures 30, a base plate 31, a membrane circuit board 32 and plural light-emitting elements 33. For succinctness, only one key structure 30 and only one light-emitting element 33 are shown in FIGS. 4 to 8. These key structures 30 are classified into some types, e.g., ordinary keys, numeric keys and function keys. When one of the key structures 30 is depressed by the user's finger, the keyboard device 3 generates a corresponding key signal to the computer (not shown). Consequently, the computer executes a function corresponding to the depressed key structure 30. For example, when an ordinary key is depressed, a corresponding English letter or symbol is inputted into the computer. When a numeric key is depressed, a corresponding number is inputted into the computer. In addition, the function keys (F1˜F12) can be programmed to provide various quick access functions.

Each key structure 30 comprises a keycap 301, a connecting element 302 and an elastic element 303. The connecting element 302 is connected between the keycap 301 and the base plate 31. Through the connecting element 302, the keycap 301 is movable upwardly or downwardly relative to the base plate 31. The elastic element 303 is penetrated through the connecting element 302, and arranged between the keycap 301 and the membrane circuit board 32. In an embodiment, the keycap 301 comprises fixed hooks 3011 and movable hooks 3012. The fixed hooks 3011 and the movable hooks 3012 are disposed on a bottom surface of the keycap 301. Moreover, the keycap 301 comprises two contacting parts 3013. The two contacting parts 3013 are disposed on two opposite edges on a bottom surface of the keycap 301. In an embodiment, the connecting element 302 is a scissors-type connecting element. Moreover, the connecting element 302 comprises a first frame 3021 and a second frame 3022. The second frame 3022 is pivotally coupled to the first frame 3021. The first frame 3021 is an inner frame, and the second frame 3022 is an outer frame.

The base plate 31 comprises a plate body 312, plural first base plate hooks 313 and plural second base plate hooks 314. The plate body 312 is located under the membrane circuit board 32. The plural first base plate hooks 313 and the plural second base plate hooks 314 are protruded upwardly from the plate body 312 and penetrated through the membrane circuit board 32.

The first end 30211 of the first frame 3021 is connected with the corresponding fixed hook 3011 of the keycap 301. The second end 30212 of the first frame 3021 is connected with the second base plate hook 314 of the base plate 31. The first end 30221 of the second frame 3022 is connected with the corresponding first base plate hook 313 of the base plate 31. The second end 30222 of the second frame 3022 is connected with the movable hook 3012 of the keycap 301. Due to the above structure, the first frame 3021 and the second frame 3022 can be swung relative to each other. Consequently, the first frame 3021 and the second frame 3022 are switched from a stacked state to an open-scissors state or switched from the open-scissors state to the stacked state. The connecting relationships between the connecting element 302, the base plate 31 and the keycap 301 are presented herein for purpose of illustration and description only.

Please refer to FIG. 7. The membrane circuit board 32 comprises an upper film layer 321, a lower film layer 322 and an intermediate film layer 323, which are arranged in a stack form. A first circuit pattern 3211 is formed on a bottom surface of the upper film layer 321. The first circuit pattern 3211 comprises first conductor lines 32112 and plural upper contacts 32111. A second circuit pattern 3221 is formed on a top surface of the lower film layer 322. The second circuit pattern 3221 comprises plural second conductor lines 32212 and plural lower contacts 32211. The plural lower contacts 32211 are aligned with the plural upper contacts 32111, respectively.

Each of the upper contacts 32111 and the corresponding lower contact 32211 are separated from each other by a spacing distance. Moreover, each of the upper contacts 32111 and the corresponding lower contact 32211 are collectively defined as a membrane switch 320. For maintaining the spacing distance between each upper contact 32111 and the corresponding lower contact 32211, the intermediate film layer 323 is arranged between the upper film layer 321 and the lower film layer 322. In addition, the intermediate film layer 323 comprises plural perforations 3231 corresponding to the plural upper contacts 32111 and the plural lower contacts 32211. Preferably but not exclusively, each of the upper film layer 321, the lower film layer 322 and the intermediate film layer 323 is made of polycarbonate (PC), polyethylene terephthalate (PET), polymethylmethacrylate (PMMA), polyurethane (PU) or polyimide (PI).

Each key structure 30 is aligned with two membrane switches 320. The two membrane switches 320 are not sheltered by the elastic element 303. While the keycap 301 of any key 30 is depressed and moved downwardly relative to the base plate 34, the first frame 3021 and the second frame 3022 of the connecting element 302 are switched from the open-scissors state to the stacked state. Moreover, as the keycap 301 is moved downwardly to compress the elastic element 303, at least one of the two contacting parts 3013 of the keycaps 301 is moved downwardly to push the corresponding upper contact 32111. Consequently, the corresponding upper contact 32111 is contacted with the corresponding lower contact 32211 through the corresponding perforation 3231. In such way, the corresponding membrane switch 320 is electrically conducted, and the keyboard device 3 generates a corresponding key signal. When the keycap 301 of the key 30 is no longer depressed, the keycap 301 is moved upwardly relative to the base plate 31 in response to an elastic force of the elastic element 303. Meanwhile, the first frame 3021 and the second frame 3022 are switched from the stacked state to the open-scissors state. Consequently, the keycap 301 is returned to its original position.

The membrane circuit board 32 further comprises accommodation spaces 324 for accommodating the corresponding light-emitting elements 33. For each key structure 30, the light-emitting element 33 corresponding to the key structure 30 is disposed within the corresponding accommodation space 324 and electrically connected with the membrane circuit board 32. The light-emitting element 33 is located under the elastic element 303. The top surface of the light-emitting element 33 is at the level higher than the top surface of the upper film layer 321 or at the same level with the top surface of the upper film layer 321. Moreover, the two membrane switches 320 are located beside two opposite sides of the light-emitting element 33. The light-emitting element 33 is a top-view light-emitting element. By acquiring electric power from the membrane circuit board 32, the light-emitting element 33 emits light beams upwardly. The light beams are projected upwardly and transmitted through the corresponding elastic element 303 and the corresponding keycap 301 sequentially. Consequently, the keycap 301 is illuminated.

For allowing the top surface of the light-emitting element 33 to be at the level higher than the top surface of the upper film layer 321 or at the same level with the top surface of the upper film layer 321, the light-emitting element 33 is connected with the first circuit pattern 3211 of the upper film layer 321 in a back-mounting manner (see FIG. 8). Since the top surface of the light-emitting element 33 is at the level higher than the top surface of the upper film layer 321 or at the same level with the top surface of the upper film layer 321, the travelling distance of the keycap 301 is not influenced by the light-emitting element 33 while the keycap 301 of the key structure 30 is depressed. In such way, the tactile feel of depressing the keycap 301 is enhanced.

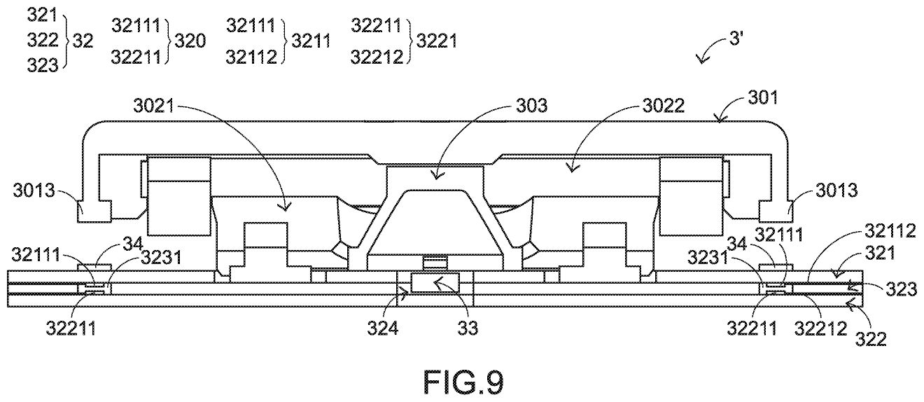

FIG. 9 is a schematic cross-sectional view illustrating a portion of a keyboard device according to a second embodiment of the present invention. The structures and functions of the components of the keyboard device 3′ which are identical to those of the first embodiment are not redundantly described herein. In comparison with the first embodiment, the keyboard device 3′ further comprises plural buffering structures 34. The buffering structures 34 are aligned with the corresponding contacting parts 3013 of the keycaps 301 and the corresponding membrane switches 320. While the corresponding keycap 301 is depressed and the contacting parts 3013 are moved downwardly toward the membrane circuit board 32, the buffering structures 34 provide the buffering efficacy. Since the membrane circuit board 32 is not directly collided by the contacting parts 3013, the possibility of causing damage of the membrane circuit board 32 is largely reduced and the use life of the keyboard device 3′ is increased.

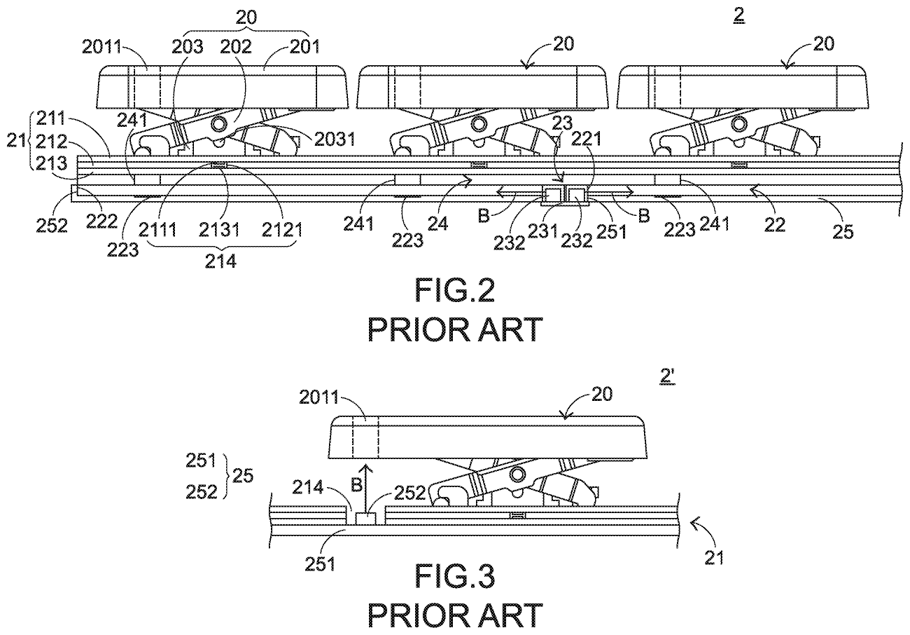

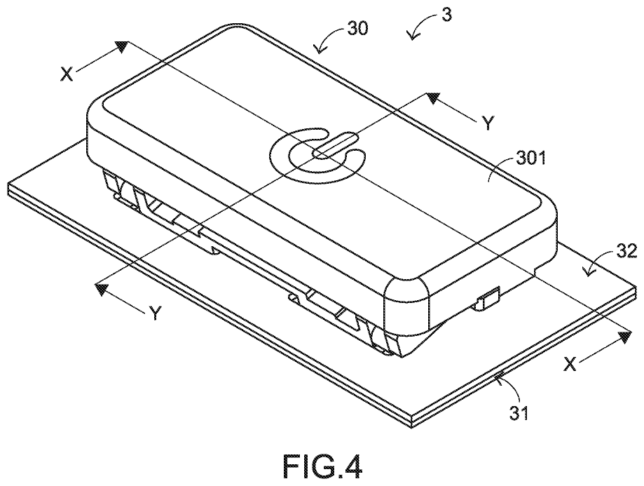

From the above descriptions, the keyboard device of the present invention has the following advantages. Firstly, the light-emitting element and the elastic element corresponding to each key structure are located at the middle region. After the light beams from the light-emitting element are projected upwardly and transmitted through the elastic element, the light beams are projected to the keycap uniformly. Consequently, the keycap has the uniform illuminous efficacy. Secondly, since the light-emitting element and the elastic element are located at the middle region, each key structure is aligned with two membrane switches and the two membrane switches are located beside two opposite sides of the light-emitting element. While the keycap is depressed and moved downwardly in an aslant manner, at least one membrane switch is triggered and the keyboard device generates the corresponding key signal. It is noted that the number of the membrane switches corresponding to each key structure is not restricted. That is, the number of the membrane switches corresponding to each key structure may be varied according to the practical requirements. Thirdly, the light-emitting element is electrically connected with the membrane circuit board to receive electric power through the membrane circuit board. Consequently, it is not necessary to additionally install other circuit board (e.g., the illumination circuit board 231 of FIG. 2 or the illumination circuit board 261 of FIG. 3) and the light guide plate (e.g., the light guide plate 22 of FIG. 2) on the keyboard device. Under this circumstance, the fabricating cost and the volume of the keyboard device are reduced. Fourthly, each key structure is aligned with one light-emitting element. Consequently, the illumination status of each key structure can be individually controlled.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all modifications and similar structures.

What is claimed is:

1. A keyboard device, comprising:
a membrane circuit board comprising at least one membrane switch;
a base plate located under the membrane circuit board;
a key structure comprising a keycap, a connecting element and an elastic element, wherein the keycap comprises at least one contacting part, the connecting element is connected between the base plate and the keycap, the keycap is movable upwardly or downwardly relative to the base plate through the connecting element, and the elastic element is arranged between the keycap and the membrane circuit board, wherein while the keycap is depressed, the elastic element is compressed and the at least one membrane switch is pushed by the at least one contacting part, wherein when the keycap is not depressed, the keycap is returned to an original position in response to an elastic force of the elastic element; and
a light-emitting element located under the elastic element and electrically connected with the membrane circuit board, and emitting plural light beams, wherein after the plural light beams are transmitted through the elastic element and the keycap sequentially, the plural light beams are outputted.

2. The keyboard device according to claim 1, wherein the at least one membrane switch comprises two membrane switches, wherein the two membrane switches are not sheltered by the elastic element, and the two membrane switches are located beside two opposite sides of the light-emitting element.

3. The keyboard device according to claim 2, wherein the at least one contacting part comprises two contacting parts, and the two contacting parts are disposed on two opposite edges on a bottom surface of the keycap.

4. The keyboard device according to claim 1, wherein the membrane circuit board further comprises an upper film layer and a lower film layer, wherein a first circuit pattern is formed on the upper film layer, a second circuit pattern is formed on the lower film layer, the first circuit pattern comprises at least one upper contact, and the second circuit pattern comprises at least one lower contact, wherein each upper contact and the corresponding lower contact are separated from each other by a spacing distance and collectively defined as the corresponding membrane switch.

5. The keyboard device according to claim 4, wherein the light-emitting element is electrically connected with the first circuit pattern on the upper film layer.

6. The keyboard device according to claim 4, wherein the membrane circuit board further comprises an accommodation space, and the light-emitting element is accommodated within the accommodation space.

7. The keyboard device according to claim 6, wherein when the light-emitting element is accommodated within the accommodation space and electrically connected with the membrane circuit board, a top surface of the light-emitting element is at a level higher than a top surface of the upper film layer or at the same level with the top surface of the upper film layer.

8. The keyboard device according to claim 4, wherein the membrane circuit board further comprises an intermediate film layer between the upper film layer and the lower film layer, so that the each upper contact and the corresponding lower contact are separated from each other by the spacing distance, wherein the intermediate film layer comprises at least one perforation corresponding to the at least one upper contact and the at least one lower contact.

9. The keyboard device according to claim 1, wherein the keyboard device further comprises at least one buffering structure, wherein the at least one buffering structure is disposed on the membrane circuit board, and the at least one buffering structure is arranged between the corresponding contacting part and the corresponding membrane switch.

10. The keyboard device according to claim 1, wherein the connecting element comprises:
a first frame, wherein a first end of the first frame is connected with the keycap, and a second end of the first frame is connected with the base plate; and
a second frame connected with the first frame and swung relative to the first frame, wherein a first end of the second frame is connected with the base plate, and a second end of the second frame is connected with the keycap.

11. The keyboard device according to claim 10, wherein the keycap further comprises a fixed hook and a movable hook, wherein the fixed hook is connected with the first end of the first frame, and the movable hook is connected with the second end of the second frame, so that the second end of the second frame is movable within the movable hook

12. The keyboard device according to claim 10 wherein the base plate comprises a plate body, a first base plate hook and a second base plate hook, wherein the plate body is located under the membrane circuit board, and the first base plate hook and the second base plate hook are protruded upwardly from the plate body and penetrated through the membrane circuit board, wherein the first base plate hook is connected with the first end of the second frame, and the second base plate hook is connected with the second end of the first frame.

13. A keyboard device, comprising:
a membrane circuit board comprising two membrane switches;
a base plate located under the membrane circuit board;
a key structure comprising a keycap, a connecting element and an elastic element, wherein the keycap comprises two contacting parts corresponding to the two membrane switches, the connecting element is connected between the base plate and the keycap, the keycap is movable upwardly or downwardly relative to the base plate through the connecting element, and the elastic element is arranged between the keycap and the membrane circuit board, wherein while the keycap is depressed, the elastic element is compressed and at least one of the two contacting parts pushes the corresponding membrane switch, wherein when the keycap is not depressed, the keycap is returned to an original position in response to an elastic force of the elastic element; and
a light-emitting element electrically connected with the membrane circuit board, and emitting plural light beams,
wherein the two membrane switches are not sheltered by the elastic element, and the two membrane switches are located beside two opposite sides of the light-emitting element.

14. The keyboard device according to claim 13, wherein the light-emitting element is located under the elastic element, wherein after the plural light beams are transmitted through the elastic element and the keycap sequentially, the plural light beams are outputted.

15. The keyboard device according to claim 13, wherein the membrane circuit board further comprises an upper film layer and a lower film layer, wherein a first circuit pattern is formed on the upper film layer, a second circuit pattern is formed on the lower film layer, the first circuit pattern comprises at least one upper contact, and the second circuit pattern comprises at least one lower contact, wherein each upper contact and the corresponding lower contact are separated from each other by a spacing distance and collectively defined as the corresponding membrane switch.

16. The keyboard device according to claim 15, wherein the light-emitting element is electrically connected with the first circuit pattern on the upper film layer.

17. The keyboard device according to claim 15, wherein the membrane circuit board further comprises an accommodation space, and the light-emitting element is accommodated within the accommodation space.

18. The keyboard device according to claim 17, wherein when the light-emitting element is accommodated within the accommodation space and electrically connected with the membrane circuit board, a top surface of the light-emitting element is at a level higher than a top surface of the upper film layer or at the same level with the top surface of the upper film layer.

19. The keyboard device according to claim 15, wherein the membrane circuit board further comprises an intermediate film layer between the upper film layer and the lower film layer, so that the each upper contact and the corresponding lower contact are separated from each other by the spacing distance, wherein the intermediate film layer comprises at least one perforation corresponding to the at least one upper contact and the at least one lower contact.

20. The keyboard device according to claim 13, wherein the keyboard device further comprises two buffering structures, wherein the two buffering structures are disposed on the membrane circuit board, and the two buffering structures are arranged between the corresponding contacting parts and the corresponding membrane switches, respectively.
